(19) United States
(12) Patent Application Publication
(10) Pub. No.: US 2022/0138374 A1
(43) Pub. Date: May 5, 2022

(54) USER-BASED DESIGN FILE MODIFICATIONS

(71) Applicant: Hewlett-Packard Development Company, L.P., Spring, TX (US)

(72) Inventors: Kristopher J. Erickson, Palo Alto, CA (US); Jarrid Wittkopf, Palo Alto, CA (US); Rafael Ballagas, Palo Alto, CA (US); David Wayne George, Palo Alto, CA (US); Lihua Zhao, Palo Alto, CA (US); William J. Allen, Corvallis, OR (US)

(73) Assignee: Hewlett-Packard Development Company, L.P., Spring, TX (US)

(21) Appl. No.: 17/414,520

(22) PCT Filed: Jun. 18, 2019
(86) PCT No.: PCT/US2019/037715

§ 371 Date: Jun. 16, 2021

(51) Int. Cl. G06F 30/20

(52) U.S. Cl. CPC G06F 30/20

(57) ABSTRACT

In one example in accordance with the present disclosure, a system is described. The system includes a reader to read an identifier associated with a part. An extractor of the system extracts, based on the identifier, a design file for the part. A modifier of the system receives user input modifying the design file and a transmitter transmits the modified design file for production of the part.

### BACKGROUND

Millions of products are made and introduced into the economic stream every day. Everything from household products to industrial machinery and all variety of products in between. These products are offered to consumers via a number of distribution channels. For example, products may be purchased via an online retailer. Consumers may also go to a brick-and-mortar store to purchase a product.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for user-based design file modifications, according to an example of the principles described herein.

FIG. 2 illustrates a user-based design file modification, according to an example of the principles described herein.

FIG. 3 is a flow chart of a method for user-based design file modifications, according to an example of the principles described herein.

FIG. 4 is a block diagram of a system for user-based design file modifications, according to another example of the principles described herein.

FIG. 5 is a flow chart of a method for user-based design file modifications, according to another example of the principles described herein.

FIG. 6 is a block diagram of a system for user-based design file modifications, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Around the world, millions of products are produced every day. Everything from household products to industrial machinery and everything in between. Via a variety of distribution mechanisms, consumers can purchase or otherwise receive these products. It has never been easier for a consumer to acquire any product they desire. While product development, manufacturing, and distribution have created an environment where product access is greater than ever, certain developments to product management may even further increase the worldwide distribution network.

One such example is inventory management. That is, a physical store may have a finite amount of space to store products. Online retailers may also be limited in the amount of product they can offer based on limitations in warehousing. Accordingly, the retailers may have to pick and choose between which products it intends to display and/or maintain inventory on. To address the matter of finite storage space, retailers engage in detailed and complex analytics to determine which products to include on a store floor, a quantity to keep on hand, and when to produce or purchase new inventory.

Moreover, manufactured parts as they are presented on a store floor may be generic and lack customization. That is, a retailer may be limited in the different models, or versions, of a product they can provide. For example, a retailer may stock a lamp with a particular coloration. It may be the case that different colorations are produced, but due to space constraints, the store cannot hold them. Moreover, it may be the case that different colorations are not produced. Accordingly, a consumer's purchasing choice is limited by 1) what a manufacturer produces and/or 2) what a retailer has on hand.

Accordingly, the present specification provides systems and methods that address this and other issues. Specifically, the present specification describes a system that includes a reader which reads an identifier associated with an object. The system then retrieves a design file for the part based on the identifier. The system then receives user input modifying the design file for the part. The system transmits the modified design file to a manufacturer for production.

In some examples, the system may be disposed on a variety of computing devices including tablets and mobile phones. Accordingly, a reader, which may be a camera disposed on a mobile phone or an RF scanner on a mobile phone, may be used. In this example, a user may simply scan an identifier associated with a part and enter a user interface wherein they can alter select properties of the part resulting in a customized version of the part particularly tailored to that user. The system then sends the modifications to the design file to a manufacturer such that a customized part may be generated based on the selected customizations.

Specifically, the present specification describes a system. The system includes a reader to read an identifier associated with a part. An extractor of the system extracts a design file for the part based on the identifier, and a modifier of the system receives user input modifying the design file. A transmitter of the system transmits the modified design file for production of the part.

The present specification also describes a method. According to the method, an identifier that is associated with the part is read. A design file is extracted for the part based on the identifier and modified based on user input. A modified design file may then be transmitted for production of the part.

In another example, the system includes a reader to read an identifier from a storage element embedded in a three-dimensional (3D) printed part, an extractor to extract a design file for the 3D printed part based on the identifier, and a modifier to receive user input modifying the design file. In this example, the system also includes a user interface to 1) visualize the 3D printed part and 2) visualize modifications to the 3D printed part. A validation engine of the system verifies the user input modifications to the design file and a transmitter transmits a verified modified design file for production of the part.

As described above, in some examples the identifier is stored on a storage element that is embedded in, or disposed on, the part itself. By attaching a storage element, such as a radio-frequency identification (RFID) chip to a part, each part can obtain a unique identity. Inventory management is facile using such RFID-tagged parts as scanning can be remote and largely automated. This can lead to auto-reordering of products when desired. Such RFID tags also present more effective and accurate product management. For example, a retailer may inventory just a sample part that a user can scan. This scanning can either trigger ordering and shipment of the part directly to their home, or may present a user interface wherein modifications to the part can be made before a part is ordered or shipped.

Such systems and methods 1) facilitate enhanced customization of parts for consumer use; 2) allows a retailer to hold fewer inventory on particular products; 3) allows a retailer to offer a wider variety of inventoried products; and 4) alleviates the reliance on complex inventorying operations. However, it is contemplated that the devices disclosed herein may address other matters and deficiencies in a number of technical areas.

As used in the present specification and in the appended claims, the term, “reader,” “extractor,” “modifier,” “transmitter,” “validation engine,” and “authenticator,” refer to various hardware components, which may include a processor and memory. The processor may include the hardware architecture to retrieve executable code from the memory and execute the executable code. As specific examples, the reader as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the respective component, cause the component to implement at least the functionality described herein.

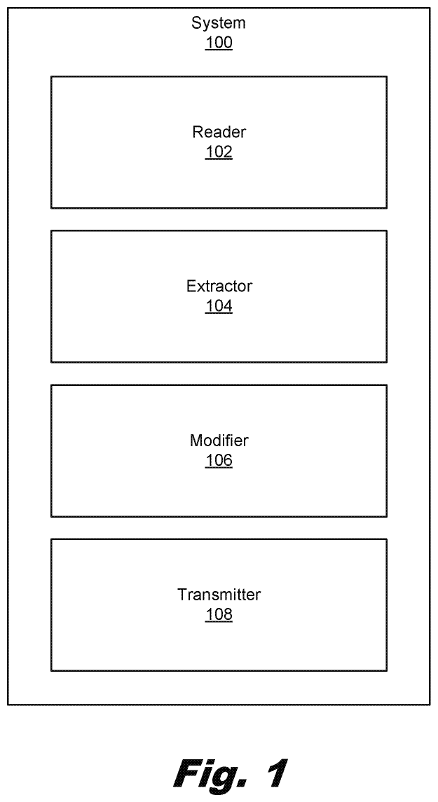

Turning now to the figures, FIG. 1 is a block diagram of a system (100) for user-based design file modifications, according to an example of the principles described herein. In general, the system (100) may be disposed in any variety of computing devices including mobile devices, smart phones, tablets, etc. As described above, the system (100) provides for the alteration of a design file for a part and transmits the altered design file for production of the modified part.

The system (100) includes a reader (102) to read an identifier associated with a part. That is, each part may be uniquely identified via an identifier such as an ID number. In some examples, the identifier may be read from a storage element disposed on the part itself. For example, a part may include an RFID tag that is disposed on a surface of the part. In this example, the reader (102) which may be an RF scanner can interrogate the storage element to acquire the identifier. In another example, the storage element may be embedded in the part itself.

The storage element may be of a variety of types. For example, in some cases, the part is a 3D printed part. In this example, the identifier may be embedded in the 3D printed part. In this example, an additive manufacturing system forms the 3D printed part. This may be done in a number of ways including multi-jet fusion, metal-jet fusion, polymer sintering, selective laser sintering, and selective laser melting. In yet another example, the additive manufacturing process may involve using a light source to cure a liquid resin into a hard substance. Such an operation may be referred to as stereolithography.

In any of these examples, deposition of layers of build material may be paused such that a storage element such as an RFID tag or other electronic tag can be placed in a body of the 3D printed part. Printing is resumed, thereby embedding the storage element in the body of the 3D printed part. While specific reference is made to RFID storage elements, other types of storage/transmission elements may also be used including UFH and other wireless communication and near field communication.

In some examples, the storage element may be simply attached to a surface of a part, for example via an adhesive. In yet another example, the storage element may be printed on a surface of the part. While specific reference is made to many ways to dispose a storage element on a part, any number of methods may be used so long as an identifier is written onto and readable from a part.

The reader (102) may be of a variety of types and may be selected based on the storage element. For example, the storage element may be a radio-frequency identification (RFID) tag. In this example, the reader (102) may be an RFID reader. In this example, the RFID tag receives electromagnetic energy from the RFID reader (102) antenna. Then, using its own internal battery or energy harvested from the reader (102), the tag sends radio waves back to the reader (102). The reader (102) picks up the RFID tag radio waves and decodes them into an identifier. Using an RFID tag and an RFID reader (102) may allow for information transmission without line-of-sight communication. That is, as described above, in some examples, the storage element is embedded into build material, i.e., the 3D printed part. In this example, the information stored on the RFID chip can be read by a reader (102) through the body of the 3D printed part. As described above, such an RFID reader (102) may be found on a portable computing device such as a smart phone, tablet, or other handheld electronic device.

While particular reference is made to a particular reader (102), such as one to read an RFID tag, a variety of types of readers (102) may be implemented that rely on different communication protocol. For example, the reader (102) may be a UHF wireless, or other type of wireless scanner or a near-field communication scanner among others.

The system (100) also includes an extractor (104) to extract a design file for the part based on the identifier. That is, each part has a design file which details various aspects of the production of the part. In a specific example, where the part is a 3D printed part, the design file is a print file which indicates print conditions for the 3D printed part.

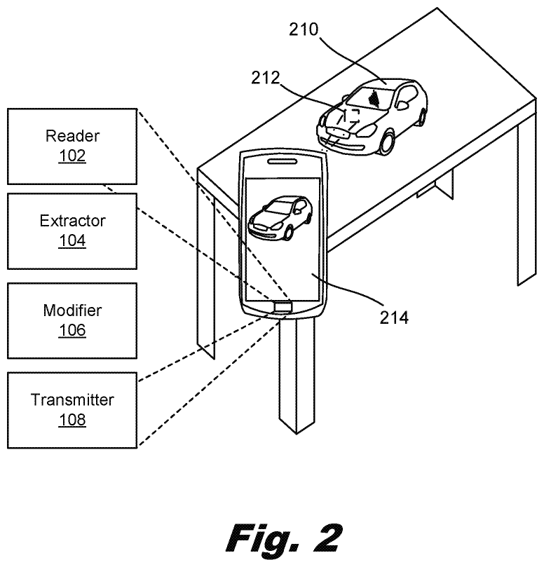

Moreover, as used in the present specification and in the appended claims the term “extract” refers to an operation wherein information/data is pulled from the 3D printed object (FIG. 2, 218) or the database. That is, as mentioned above, data may be stored on a storage element on the 3D printed object or at a remote location identified by the storage element. Data that is extracted from either location is information that is read from those locations. For example, a database may include information, and the extractor (1334), may upon receiving an indication of the identifier, read the information from the database. That is, the identifier may point to an address in the database where the information about post processing is held, and the extractor may receive that address, locate the address on the database, and read, or extract, the contents found at that location.

The design file may indicate a variety of other pieces of information relating to the formation of the part. For example, the design file may indicate post-processing operations executed on the part and in the specific case of 3D printed parts, the post processing operations may be post-additive manufacturing operations. The design file may also indicate raw material properties, part dimensions, and part characteristics. While specific reference is made to a few types of information included in the design file, the design file may include any variety of data relating to the building and distribution of a particular part.

The design file may be extracted from any number of sources. In one example, the storage element may include just a unique identification of the part and the design file itself may be located on a remote database which is identified via the unique identification. In this example, the design file is extracted from the database. That is, the identifier may reference a location on a remote server where the design file is located. Accordingly, the reader (102) upon reading the identifier provides a location from which the extractor (104) can collect the design file.

However, if a tag with more storage space is used, additional information could possibly be on-boarded onto the chip itself or a connected memory module. For example, the storage element may include the identifier and the design file, or a portion thereof. In this example, the design file may be extracted from the storage element on, or embedded in, the manufactured part. That is, while reference was made to an RFID tag being the storage element, other and larger storage elements may be embedded or disposed on the part, which larger storage elements may include additional space on which the design file may be written. The contents of this storage element may be extracted by the extractor (104).

Associating this information with an identifier on the part enhances the manufacturing operation. That is, as described above, if a user desires to make a modification to a product, they would have to reach out personally to the manufacturer to design and implement their changes. However, using the current system (100) such data extraction is automated.

The system also includes a modifier (106) to receive user input modifying the design file. That is, upon formation the manufacturer may specify certain features of the part that may be customized by a user. The modifier (106) may provide a user interface wherein the consumer can alter the design file either in an unrestricted manner or based on modification criteria set by the manufacturer or another user.

For example, the user may be able to modify print conditions, post processing operations, raw material properties, part dimensions, and part characteristics. In one particular example, a reader (102) which may be a camera or an RF scanner on a mobile device, may read an identifier which is embedded in a model car. The extractor (104) may extract the design file for the model car and from this, the user may select a particular size for the model car and may also pick a particular color scheme for the car.

Other examples of characteristics of a part design file that may be modified include, but are not limited to, part color, part transparency, part finish, part lettering, emblems/logos on the part, and additional design features incorporated into the part, among others. While particular reference is made to a few alterations that may be made to the design file, any variety of design changes could be made.

With the design file modified, a transmitter (108) of the system (100) transmits a modified design file for production of the part. That is, the modified design file may be transmitted to a production facility, which may or may not be the original designer of the part, such that the part may be produced and provided to the user.

Accordingly, the system (100) as described herein provides a way to alter and customize a design file to fit the criteria of a variety of different consumers. That is, a user is no longer limited by the existing options for a particular part, but can customize a part based on their own criteria. Moreover, such a system is effective for retailers as it frees up physical space. That is, the retailer, rather than inventorying various options of a particular object, may hold just a sample product. The system (100) is then relied on to provide the part variations, on a per-user level. Such a system (100) may facilitate the customization of a sample part with minimal knowledge of computer-aided drafting (CAD) or any additive manufacturing process.

FIG. 2 illustrates a user-based design file modification, according to an example of the principles described herein. In the example depicted in FIG. 2, the part (210) is a model car displayed on a table. In this example, the reader (102) may interrogate the object (210) which includes an embedded storage element (212). In the example depicted in FIG. 2, the storage element (212) is indicated in dashed lines to represent its location internal to the object (210). Upon reading, the extractor (104) extracts the design file, which may be located on the storage element (212) itself or may be referenced via a pointer located on the storage element (212).

The modifier (106) then presents a user interface (214) which allows the design file to be modified based on any number of criteria. Once a user has modified the design file, a transmitter (108) sends the modified design file to a destination where the part may be produced based on the modifications by the user. Thus, as described above, such a system (FIG. 1, 100) provides for the customization of a part (210) by allowing a user to specifically alter the design file associated with the part (210). As described above, in some examples, the part (210) may be a 3D printed part with no specific post processing operations having been conducted.

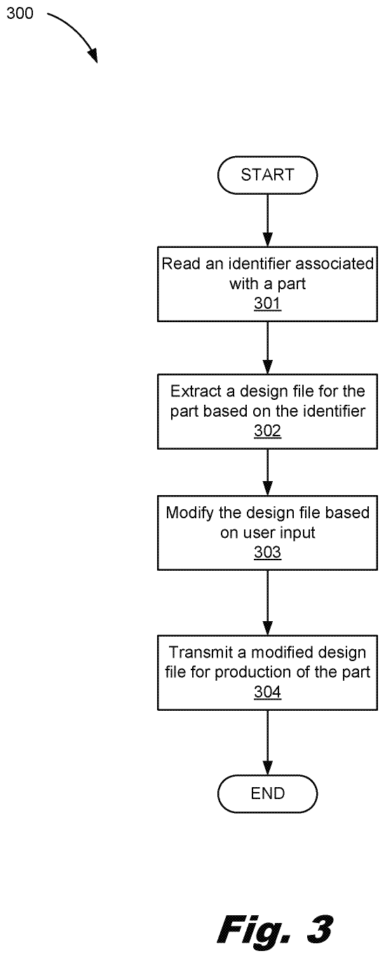

FIG. 3 is a flow chart of a method (300) for user-based design file modifications, according to an example of the principles described herein. According to the method (300) an identifier that is associated with the part (FIG. 2, 210) is read (block 301), in some examples from a storage element (FIG. 2, 212) associated with the part (FIG. 2, 210). As described above, the identifier may be found on a storage element (FIG. 2, 212) that is disposed on, or in the part (FIG. 2, 210). Also as described above this may be done in any number of ways including using an RFID scanner to interrogate an RFID storage element in a 3D printed part.

An extractor (FIG. 1, 104) then extracts (block 302) a design file for the part (FIG. 2, 210) based on the identifier. That is, as described above, each part (FIG. 2, 210) is associated with a design file that contains all the parameters for formation of the part (FIG. 2, 210) including print conditions, post processing operations, raw material properties, part dimensions, and part characteristics, among others. The design file may be extracted (block 302) from the storage element (FIG. 2, 212) itself or from a database associated with the part (FIG. 2, 210). In the case the design file is extracted (block 302) from a database, the location of the design file may be mapped to the identifier. That is, the identifier may include a pointer that dereferences the location in the database where the design file is stored. In some examples, the extracted information may be encrypted to protect against unwanted access and/or manipulation. Such an encryption could be used to verify the accuracy and integrity of returned data to ensure it has not been altered or tampered with.

The extracted (block 302) design file may then be modified (block 303) based on user input. That is, certain aspects of a part (FIG. 2, 210) may be modifiable. For example, colors, dimensions, lettering, etc. may all be alterable for a given part (FIG. 2, 210). The modification (block 303) stage allows a user to modify these modifiable aspects. In some examples, the features of the part (FIG. 2, 210) that are modifiable are selected by a manufacturer.

The modifications (block 303) may be received via any number of mechanisms. For example, pull down menus may be presented for each modifiable feature and options for those modifications may be presented to a user. In another example, a field may be presented wherein a user can manually enter in any desired modification. In yet another example, the modifications may be received via a user interface (FIG. 2, 214). Through such a user interface a user may manipulate a visualization of the part (FIG. 2, 210) in any number of ways which may be set by the manufacturer or which may be free form. In any of these examples, the modifier (FIG. 1, 106) may include a guided user interface to assist a user in selecting available modifications, and customizing the part (FIG. 2, 210) based on the modifications. Thus, a user who may have little to no knowledge regarding 3D printing or 3D modeling may be guided through a process wherein they can customize a particular 3D printed part, or other part (FIG. 2, 210) based on their own criteria.

The modified design file is then transmitted (block 304) to a location where the part (FIG. 2, 210) may be produced. For example, the design file may be transmitted (block 304) back to the original manufacturer such that an authenticated, but customized, version of the part (FIG. 2, 210) may be made for the customer, and which may be provided to the customer.

As described above, the design file may include information relating to the production of a part (FIG. 2, 210) and specific examples of information contained in the design file have been previously mentioned. In addition to that information, the design file may include other information. Examples include, but are not limited to assembly information, packing information, printing instructions, gift-wrapping (if selected for example), and shipping information for the consumer. In other words, the design file may include all the information to get the customized part (FIG. 2, 210) in the consumers hand as specified via the modifications (block 303) received.

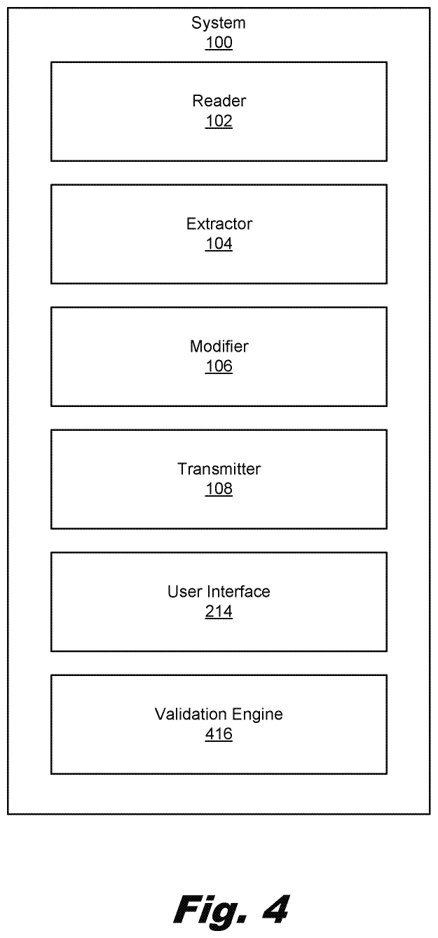

FIG. 4 is a block diagram of a system (100) for user-based design file modifications, according to another example of the principles described herein. As described above, the system (100) includes a reader (102). In one example, the reader (102) is to read an identifier from a storage element (FIG. 2, 212) embedded in a 3D printed part (FIG. 2, 210). The system (100) also includes an extractor (104) to extract a design file for the part (FIG. 2, 210) based on the identifier, a modifier (106) to receive user input modifying the design file, and a transmitter (108) for transmitting a modified design file for production of the part (FIG. 2, 210), which may be a 3D printed part.

In some examples, the system (100) includes additional components. For example, the system (100) may include a user interface (214). As described above, the user interface (214) may allow for visualization of the part (FIG. 2, 210) as well as the modifications to the design file. That is, the design file, which may be a text-based file, may be converted into a graphic display such that a user may visualize the modifications they intend to make.

In addition to providing a visualization of the part (FIG. 2, 210) and modifications, the user interface (214) may also present predetermined modification options for the design file. That is, while there are innumerable design changes that could be made to a particular part (FIG. 2, 210), there may be a finite number of changes that a particular facility can accommodate. For example, a particular manufacturing facility may accommodate certain surface finishes, but may not be able to accommodate all contemplatable surface finishes. Accordingly, the user interface (214) may present those modifications which are allowed based on any number of criteria including manufacturing constraints. Examples of modification options that may be presented include, but are not limited to dimensional alteration and post processing operations. While particular reference is made to specific modification options, any variety of modification options may be made available and presented to the consumer.

In another example, certain modifications may be prevented. For example, a particular manufacturer may not support a particular modification as it may detract too much from aesthetic criteria set by the manufacturer. Accordingly, those undesired customizations are not presented, and thereby not available, to modifying users. The prevention of these modifications may be enforced in a number of ways. For example, a designer may set certain ranges for values or a set of accepted values. As a particular example, the designer may indicate that for a particular model car, those colors that are acceptable candidates. The designer may indicate that other alternatives are not permissible.

As yet another example, certain modification may, for safety reasons, be ill-advised. Accordingly, in this example, the presented modification options would not include those modifications that may result in a safety concern. In a specific example, modifications that may result in a safety concern may be designated by an administrator. For example, a technician may determine that certain dimensional aspects should be maintained to ensure a safe operating environment. As a particular example, the technician may indicate a minimal thickness of legs of a stool so as to support the weight of an individual.

In yet another example, an original designer of the part may place certain protections and/or restrictions on modifications for protecting artistic aspects of the part (FIG. 2, 210).

While specific reference is made to certain criteria by which modification options are presented or blocked, any number of modification options may be presented or blocked based on any number of criteria. For example, a manufacturer may obscure certain features, such as internal structures, so as to protect a relevant feature from misappropriation by an unscrupulous third party.

Moreover, while particular mention is made of user-defined restriction on modifications, other ways to prevent such modifications may also be determined. For example, a database may include information related to particular failures of a product and the system may, via this information, indicate that certain adjustments may result in a failure and may therefore prevent such a modification.

As yet another example, modifications may be prevented if they differ by too great a degree from a sample. That is, a sample may have particular dimensions, or particular color values associated with it. If a user selects a modification that differs in dimension by greater than a predetermined threshold amount, the system may prevent such a modification.

In another example, the user interface (214) may be able to present other options such as packaging and shipping options. In one particular example, the user interface (214) may present estimated costs and delivery times based on the selected customizations. That is, as can be imagined, certain customizations may be more costly and complex than others and may therefore result in a higher cost and longer manufacturing time. The user interface (214) by presenting this information to the user may provide even more valuable information regarding the customization of a produced part (FIG. 2, 210).

As yet another example, the user interface (214) may provide environmental information such as a carbon footprint of the selected option set and/or recyclability of the ultimately produced item.

The system (100) may also include a validation engine (416) to verify the user modifications to the design file. For example, the validation engine (416) may ensure that the user's modifications will not result in structure failure. As another example, it may be the case that the design file has certain restrictions placed thereon, which restrictions indicate particular features/aspects of a part (FIG. 2, 210) that have been protected, or otherwise designated as being non-modifiable. The reason that these features may be marked as protected may vary and be based on any number of criteria.

As a particular example, a design file restriction on a pair of eyeglasses may have maximum dimensions allowable. Accordingly, the validation engine (416) may ensure that the eyeglass modifications do not exceed the maximum dimensions available. Such a validation engine (416) thereby ensures that the modifications are feasible, safe, or otherwise satisfy the criteria placed on the design file. In other words, the validation engine (416) ensures that the modifications fall within predefined bounds. In this example, the modified design file that is transmitted by the transmitter (108) is a verified modified design file.

In some examples, the transmitter (108) may transmit additional information. For example, it may be the case that the device to manufacture the part (FIG. 2, 210) is located nearby. As a particular example, the store where the part (FIG. 2, 210) is displayed may have an additive manufacturing device in-house. Accordingly, a user via the user interface (214) may select an additive manufacturing device for production of the part, i.e., the additive manufacturing device found in the store. Accordingly, the transmitter (108) may transmit the additive manufacturing device selected for production of the part (FIG. 2, 210). In this example, not only is a consumer allowed to customize a part (FIG. 2, 210), but may at the same location, take possession of the customized part (FIG. 2, 210).

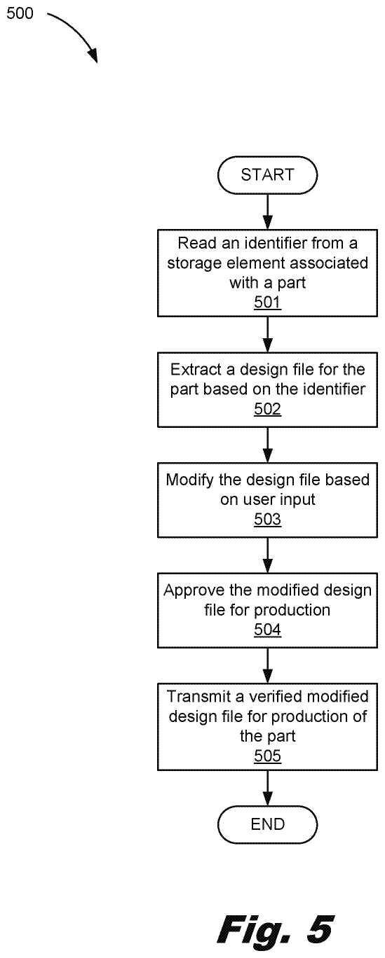

FIG. 5 is a flow chart of a method (500) for user-based design file modifications, according to another example of the principles described herein. In the example depicted in FIG. 5, an identifier is read (block 501) from a storage element (FIG. 2, 212) associate with a part (FIG. 2, 210) and the design file is extracted (block 502) based on the identifier. These operations may be performed as described above in connection with FIG. 3. Modifications (block 503) are made and in this example, the modified design file is approved (block 504) for production. That is, as described above, the validation engine (FIG. 4, 416) may verify that the modifications align with safety, aesthetic, or other criteria imposed upon the design file for any number of reasons. Once approved, the verified modified design file is transmitted (block 505) for production of the part (FIG. 2, 210) as described above in connection with FIG. 3.

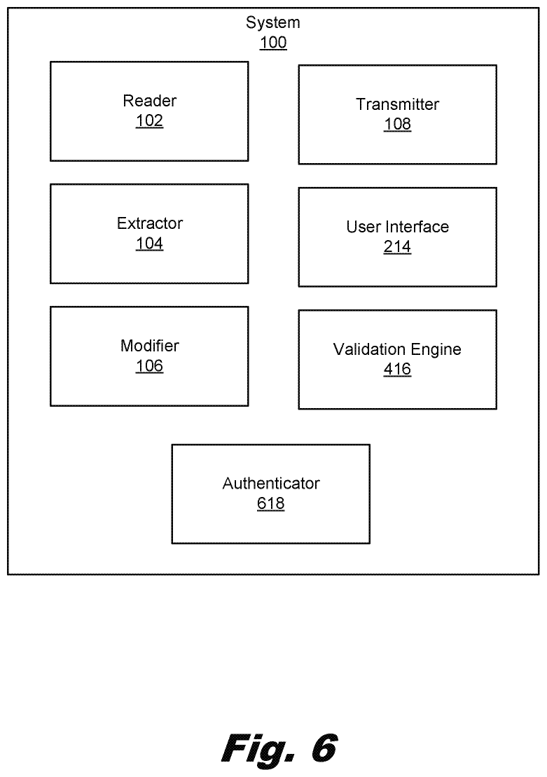

FIG. 6 is a block diagram of a system (100) for user-based design file modifications, according to another example of the principles described herein. As described above, the system (100) may include a reader (102), extractor (104), modifier (106), transmitter (108), user interface (214), and validation engine (416) as described above.

In this example, the system (100) includes additional components. Specifically, the system (100) includes an authenticator (618) to authenticate a user intending to modify the design file. That is, it may be the case that unscrupulous third parties may attempt to redesign the design file and thereby maliciously copycat the part (FIG. 2, 210). The authenticator (618) in this example would prevent such action by implementing any number of authentication protocols to ensure that the user is authorized to make changes to the design file. The authenticator (618) may also provide digital rights management access for the design file.

Such systems and methods 1) facilitate enhanced customization of parts for consumer use; 2) allows a retailer to hold fewer inventory on particular products; 3) allows a retailer to offer a wider variety of inventoried products; and 4) alleviates the reliance on complex inventorying operations. However, it is contemplated that the devices disclosed herein may address other matters and deficiencies in a number of technical areas.

What is claimed is:

1. A system comprising:
a reader to read an identifier associated with a part;
an extractor to extract a design file for the part based on the identifier;
a modifier to receive user input modifying the design file; and
a transmitter to transmit a modified design file for production of the part.

2. The system of claim 1, wherein:
the part is a three-dimensional (3D) printed part; and
the design file is a print file indicating print conditions for the 3D printed part.

3. The system of claim 1, wherein the design file specifies at least one of:
print conditions;
post-processing operations;
raw material properties;
part dimensions; and
part characteristics.

4. The system of claim 1, wherein the identifier is read from a storage element embedded in the part.

5. The system of claim 4, wherein the storage element is a radio-frequency identification (RFID) tag.

6. The system of claim 1, further comprising a user interface to:
visualize modifications to the design file; and
present predetermined modification options for the design file.

7. The system of claim 6, wherein the predetermined modification options comprise at least one of:
dimension alteration; and
post processing operations.

8. The system of claim 1, further comprising a validation engine to verify the user input modifying the design file.

9. A method comprising:
reading an identifier associated with a part;
extracting a design file for the part based on the identifier;
modifying the design file based on user input; and
transmitting a modified design file for production of the part.

10. The method of claim 9, further comprising approving the modified design file for production.

11. The method of claim 9, wherein the design file is extracted from a storage element.

12. The method of claim 9, wherein the design file is extracted from a location in a database identified by the identifier.

13. A system comprising:
a reader to read an identifier from a storage element embedded in a three-dimensional (3D) printed part;
an extractor to extract a design file for the 3D printed part based on the identifier;
a modifier to receive user input modifying the design file;
a user interface to:
visualize the 3D printed part; and
visualize modifications to the 3D printed part;
a validation engine to verify the user input modifications to the design file; and
a transmitter to transmit a verified modified design file for production of the part.

14. The system of claim 13, further comprising an authenticator to authenticate a user to modify the design file.

15. The system of claim 13, wherein the transmitter is to transmit an additive manufacturing device selected for production of the part.
